(19) United States
(12) Patent Application Publication
(10) Pub. No.: US 2019/0381833 A1
(43) Pub. Date: Dec. 19, 2019

(54) TUBELESS PNEUMATIC TIRES

(71) Applicant: Xiangpo WEI, Beijing (CN)

(72) Inventor: Xiangpo WEI, Beijing (CN)

(21) Appl. No.: 16/551,719

(22) Filed: Aug. 27, 2019

Related U.S. Application Data
(63) Continuation of application No. PCT/CN2018/077167, filed on Feb. 25, 2018.

(30) Foreign Application Priority Data
Feb. 27, 2017 (CN) 201710106681.3

(51) Int. Cl. B60C 5/12; B60C 15/06

(52) U.S. Cl. CPC B60C 5/12; B60C 15/06

(57) ABSTRACT

A tubeless pneumatic tire. A first bead at one side of the tire has a greater rigidity and/or strength, or outer size; a first lip at the same side as the first bead is provided on a first bead seat away from a hub groove and a second lip at the same side as the second bead is provided on a second bead seat close to the hub groove. An outer side of the hub is adjacent to the hub groove, so that when a vehicle is stationary on a horizontal ground and the tire is flattened without gas support, the bears all or most of a load at a side away from the hub groove. Therefore, this application can prevent the second tire bead provided on the second bead seat adjacent to the hub groove from sliding into the hub groove once a puncture occurs during the high-speed driving, avoiding the traffic accidents caused by the loss of control of braking and steering.

### CROSS-REFERENCE TO RELATED APPLICATIONS

This application is a continuation of International Patent Application No. PCT/CN2018/077167, filed on Feb. 25, 2018, which claims the benefit of priority from Chinese Patent Application No. 201710106681.3, filed on Feb. 27, 2017. The contents of the aforementioned application, including any intervening amendments thereto, are incorporated herein by reference in its entirety.

### TECHNICAL FIELD

This application relates to wheels for automobiles, and more specifically to a tubeless pneumatic tire.

### BACKGROUND

In the case of the occurrence of puncture, a tilt will happen to the automotive body, leading to a change in the wheel camber, where the wheel camber refers to an angle between the wheel and a vertical line of the ground where the wheel are in contact. In the case that the tire is opened in a splayed shape, the camber is called a negative camber, and when the tire is opened in a “V” shape, the camber at this time is a positive camber. The negative and positive cambers are schematically shown in FIG. 12, where the wheel is a right wheel of a vehicle.

It will be extremely dangerous that a puncture happens to the tire, especially the steering wheel, when the vehicle is driven at a high speed. In addition, the steering wheel is generally provided with a small camber, which is almost perpendicular to the ground to ensure the flexibility and stability of the steering, so that the steering wheel will have a positive camber once a puncture occurs and one side of the rim at the outer side of the hub will be first in contact with the ground. Almost all commercially available hubs are hubs assembled such that the rim at the outward-facing side is close to the groove of the hub when the hub is mounted at the vehicle. At this time, as long as the tire is subjected to a certain lateral force, the bead will slide into the groove of the hub, and after that, the braking and steering of the vehicle will be out of control, easily causing the traffic accidents.

In the prior art, an annular support belt is generally provided in the groove of the hub to seal the groove of the hub to prevent the tire from escaping from the hub bead seat and sliding into the groove of the hub, thereby avoiding the traffic accidents. However, this method has the following defects. (1) The installation is complicated and the disassembly is inconvenient due to the involvement of special tools. Specifically, during the installation, the tire is first mounted on the hub, and then flattened by a special tool to make the groove exposed for the installation of the annular support belt, and after that, the tire is inflated; during the disassembly, the tire is first flattened by a special tool to make the groove exposed for the disassembly of the annular support belt, and then the tire is disassembled. (2) This method will lead to a larger wheel weight, increasing the oil consumption. (3) This method requires high cost. (4) Though the bead can be avoided to slide into the groove, it is very easy for the bead to slip off the bead seat, and it will be difficult for the driver to precisely control the vehicle once the bead slips off the bead seat.

Self-supporting run-flat tires with thickened sidewalls are generally used in the prior art to prevent the bead from escaping from the hub bead seat and sliding into the groove, however, this technique still has the following defects. (1) The strengthened sidewalls make the tire harden, reducing the comfortability of the vehicle. (2) This technique involves great difficulty in the installation and requires a special tire changer. (3) This technique leads to a large wheel weight and poor maneuverability, and also involves high oil consumption, so that it is not environmentally friendly. (4) This technique requires high cost. (5) This technique involves limited protection when a puncture occurs at the corner.

This application provides a tubeless pneumatic tire, which can not only ensure the comfortability during the normal driving, but also prevent the bead from sliding into the groove of the hub when a puncture occurs, avoiding the loss of control of braking and steering when a puncture occurs during the high-speed driving. In addition, this application can effectively overcome the defects in the prior art, specifically, the installation and disassembly of the tire provided herein can be performed by an ordinary tire changer without using an additional tool, and the tire of this application has light weight, good comfortability and low cost and is energy-saving and environmentally friendly.

### SUMMARY

An object of this application is to provide a tubeless pneumatic tire to solve the defects in the prior art that the bead will slide into the groove of the hub when a puncture occurs during the high-speed driving and the braking and steering will be out of control when a puncture occurs, improving the safety during the driving.

The technical solutions of this application are described as follows.

This application provides a tubeless pneumatic tire, comprising: a first bead and a second bead;

wherein a rigidity of the first bead is greater than a rigidity of the second bead, and/or a strength of the first bead is of the second bead;

a first lip at the same side as the first bead is provided on a first bead seat away from a hub groove; and

a second lip at the same side as the second bead is provided on a second bead seat close to the hub groove.

In an embodiment, when a vehicle is stationary on a level ground and the tubeless pneumatic tire is flattened without support by gas air pressure, an inner surface of the first bead is attached to an inner surface of the tubeless pneumatic tire and the tubeless pneumatic tire at a side away from the hub groove bears all or most load.

In an embodiment, a load borne by the tubeless pneumatic tire at the side away from the hub groove is at least 1.1 times more than the tubeless pneumatic tire at a side close to the hub groove.

In an embodiment, the first bead is greater than the second bead.

In an embodiment, the first bead is provided with a first thickening portion at an outer surface above a first rim flange away from the hub groove, and/or an inner surface of the first bead is provided with a second thickening portion.

In an embodiment, the first bead comprises a first apex; the second bead comprises a second apex; and the first apex is greater than the second apex in outer size.

In an embodiment, at least one of materials used in respective portions of the first bead has a rigidity greater than that of a material used in the corresponding portion of the second bead, and/or has a strength greater than that of a material used in the corresponding portion of the second bead.

In an embodiment, the first bead comprises a first apex; the second bead comprises a second apex; and a rigidity of the first apex is greater than that of the second apex, and/or a strength of the first bead apex is greater than that of the second apex.

In an embodiment, a first rim flange away from the hub groove is the same as a second rim flange close to the hub groove in diameter; and the second rim flange is arranged at an outside of a vehicle.

In an embodiment, the second bead is arranged at the second bead seat at an outside of a vehicle; the first bead is provided with a plurality of reinforcing members at a position above a first rim flange away from the hub groove; the plurality of reinforcing members, with an elastic modulus at 20° C. of more than 2000 MPa, are uniformly distributed on a circumference of the first bead.

In an embodiment, the reinforcing members are made of aluminum alloy, steel, alloy steel, zinc alloy, carbon fiber, nylon or glass fiber.

In an embodiment, the reinforcing members are formed by die casting, injection molding, forging or extrusion.

In an embodiment, when a vehicle is stationary on a level ground and the tubeless pneumatic tire is flattened without support by gas air pressure, a height of the reinforcing members along a diameter of the tubeless pneumatic tire is greater than a product of a distance between projections of the first rim flange and a second rim flange in an axial direction of a rim and a tangent value of a wheel camber.

This application also provides another tubeless pneumatic tire, comprising a first bead and a second bead;

wherein the first bead is greater than the second bead in outer size;

a first lip at the same side as the first bead is provided on a first bead seat away from a hub groove; and

a second tire bead at the same side with the second bead is provided at a second bead seat close to the hub groove.

In an embodiment, the first bead is provided with a first thickening portion at an outer surface above a first rim flange away from the hub groove, and/or an inner surface of the first bead is provided with a second thickening portion.

In an embodiment, when a vehicle is stationary on a level ground and the tubeless pneumatic tire is flattened without support by air pressure, an inner surface of the first bead is attached to an inner surface of the tubeless pneumatic tire and the tubeless pneumatic tire at a side away from the hub groove bears all or most load.

In an embodiment, a load borne by the tubeless pneumatic tire at the side away from the hub groove is at least 1.1 times more than the tubeless pneumatic tire at a side close to the hub groove.

In an embodiment, the first bead comprises a first apex; the second bead comprises a second apex; and the first apex is greater than the second apex in outer size.

In an embodiment, a first rim flange away from the hub groove is the same as a second rim flange close to the hub groove; and the second rim flange is arranged at an outside of a vehicle.

In an embodiment, the first bead is greater than the second bead in height.

In an embodiment, a gap is provided between adjacent reinforcing members.

In an embodiment, the gap is filled with a rubber material.

In an embodiment, the first bead at one side of the reinforcing members is configured to have such a size that the first bead at one side of the reinforcing members firstly bears the load in the process of the pressure in the tire lowering from normal air pressure to 0 when a vehicle is stationary on a level ground.

This application has the following beneficial effects.

When a vehicle is stationary on a level ground and the tubeless pneumatic tire is flattened without support by air pressure, the tire bears all or most load at a side away from the hub groove, preventing the second lip from sliding into the hub groove and avoiding the loss of control of braking and steering once a puncture occurs to reduce the occurrence of traffic accidents. The increase in the size or rigidity and/or strength of the bead portion at one side of the tire does not affect the normal assembly of the tire. In addition, since the thickness of the elastic wall of the side wall of the tire is kept constant, the comfortability during the normal driving is not or less affected.

The first lip at the same side as the first bead is provided on a first bead seat away from a hub groove and the second lip at the same side as the second bead is provided on a second bead seat close to the hub groove. When a puncture occurs during the driving, the tire bears all or most load at a side away from the hub groove, preventing the second lip from sliding into the hub groove and avoiding the loss of control of braking and steering once a puncture occurs to reduce the occurrence of traffic accidents. Further, this application can also reduce the impact of the vehicle to the hub at the side away from the hub groove, protecting the hub from being damaged. By improving the rigidity and/or strength of some materials used in the bead, it can be ensured that the first bead has a higher load-bearing capacity when the first and second beads respectively provided at two sides of the tire share the same size, avoiding or reducing the increase in the tire weight.

The first lip at the same side as the first bead having a larger size is arranged at the first bead seat away from the hub groove and the second lip at the same side as the second bead having a smaller size is arranged at the second bead seat close to the hub groove. The first bead is provided with a first thickening portion at an outer surface above a first rim flange away from the hub groove, and/or an inner surface of the first bead is provided with a second thickening portion. The tire at a side away from the hub groove bears all or most load, preventing the second lip from sliding into the hub groove and avoiding the loss of control of braking and steering once a puncture occurs to reduce the occurrence of traffic accidents. In addition, this application can also reduce the impact of the vehicle to the hub at the side away from the hub groove, protecting the hub from being damaged. The manufacture of the apex is independent in the production of a tire, and it involves a simple process to increase the size of the apex at a side where the tire bears all or most load.

The sidewall of the first lip at the side where the tubeless pneumatic tire bears all or most load is made of a material which has a larger friction coefficient than rubber and the inner surface of the rim, so that the friction between the tire and the inner surface of the rim can be improved after the tire is unseated, avoiding or reducing the relative movement between the tire and the hub.

When a vehicle is stationary on a level ground and the tire is flattened without support by air pressure, the tire bears all load at a side away from the hub groove, which can effectively prevent the second lip close to the hub groove from sliding into the hub groove after a puncture occurs.

When a vehicle is stationary on a level ground and the tire is flattened without support by air pressure, the tire bears most load at a side away from the hub groove, and a load borne by the tire at the side away from the hub groove is at least 1.1 times more than the tire at a side close to the hub groove, preventing the hub from being excessively impacted by the vehicle at a side away from the hub groove and effectively protecting the hub from being damaged.

The first bead is provided with a plurality of reinforcing members at a position above the first rim flange. The reinforcing members, with an elastic modulus at 20° C. of more than 2000 MPa, are uniformly distributed on a circumference of the first bead, which can ensure that it is not easy to compress and deform the reinforcing member when there is no air pressure in the tire. Since the reinforcing member has a circular arc shape and a certain length, the contact area between the reinforcing member and the first rim flange can be increased, which can protect the first rim flange from undergoing excessive impact when a puncture occurs during the high-speed driving, protecting the first rim flange from being damaged.

A gap is provided between the adjacent reinforcing members and is filled with a rubber material, which ensures that the first bead can be easily bent and deformed, facilitating the disassembly and assembly of the tire.

When a vehicle is stationary on a level ground and the tire is flattened without support by air pressure, a height of the reinforcing members along a diameter of the tire is greater than a product of a distance between projections of the first rim flange and a second rim flange in an axial direction of a rim and a tangent value of a wheel camber, which ensures that the first bead at one side of the reinforcing members can firstly bear the load and bear all or most load in the process of the pressure in the tire lowering from normal air pressure to 0 when a vehicle is stationary on a level ground, preventing the second lip closet to the hub groove from sliding into the hub groove.

### BRIEF DESCRIPTION OF THE DRAWINGS

FIG. 1 is a cross-sectional view of a tubeless pneumatic tire according to the invention.

FIG. 2 is a cross-sectional view of a hub and a tubeless pneumatic tire in an inflation state.

FIG. 3 is another cross-sectional view of a hub and a tubeless pneumatic tire in an inflation state.

FIG. 4 is yet another cross-sectional view of a hub and a tubeless pneumatic tire in an inflation state.

FIG. 5 is a cross-sectional view of a hub and an ordinary tire in an inflation state.

FIG. 6 is a cross-sectional view of a hub and an ordinary tire being flattened without air pressure.

FIG. 7 is a cross-sectional view of a hub and a tubeless pneumatic tire being flattened.

FIG. 8 schematically shows a hub.

FIG. 9 is a cross-sectional view of a hub and a tubeless pneumatic tire in an inflation state.

FIG. 10 schematically shows the circular distribution of the reinforcing members.

FIG. 11 schematically shows the rim when the steering wheel is flattened to be free of air pressure.

FIG. 12 schematically shows the camber of the right wheel.

In the drawings: 10—tubeless pneumatic tire; 11—third thickening portion; 12—first bead; 13—first apex; 14—second thickening portion; 15—second bead; 16—first thickening portion; 17—first lip; 18—second lip; 19—second apex; 20—ordinary tire; 30—hub; 31—first rim flange; 32—first bead seat; 33—hub groove; 34—second bead seat; 35—second rim flange; 36—rim inner surface; 37—rim; 38—outside of the hub; 39—distance between projections of the two rims in the axial direction of the rim; 40—hub assembly of a tubeless pneumatic tire; 50—ordinary tire hub assembly; 60—level ground; 101—tire ply; 102—reinforcing member; 103—gap; 104—angle equal to the camber; and 105—height difference.

### DETAILED DESCRIPTION OF EMBODIMENTS

Technical solutions of this application will be further illustrated below with reference to the embodiments and accompanying drawings.

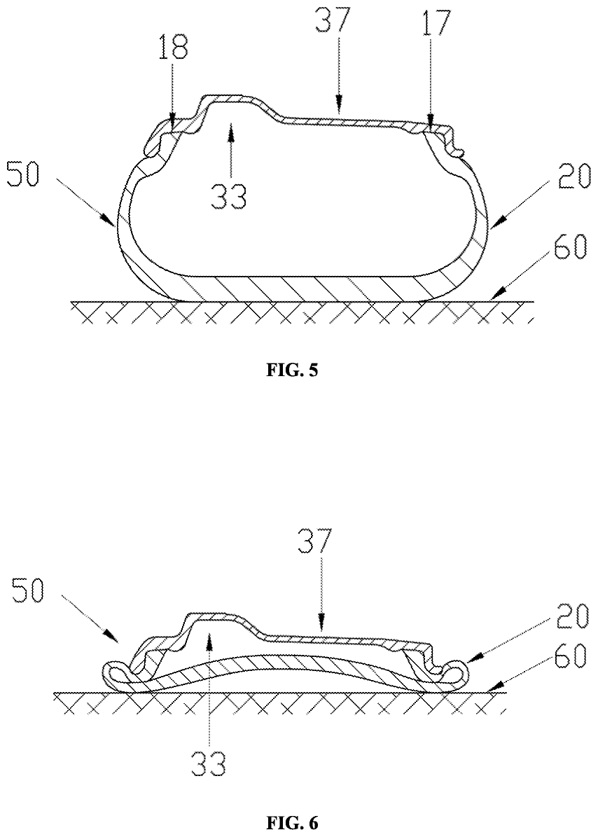

As shown in FIGS. 5, 6 and 8, in an ordinary tire hub assembly 50, an ordinary tire 20 is provided on a rim 37. On a hub 30, a first rim flange 31 away from a hub groove 33 and a second rim flange 35 close to the hub groove 33 have the same shape and diameter, and the second rim flange 35 close to the hub groove 33 is provided at an outside of a vehicle. When a puncture occurs to the vehicle during the high-speed driving on a level ground 60, the ordinary tire 20 will be flattened and the loads on both sides of the wheel are similar or the load on the left side is relatively large. In the case that the ordinary tire 20 undergoes a rightward lateral force applied by the level ground 60, it is easy for a second lip 18 at the left side to slide from a second bead seat on the rim 37 close to the hub groove 33 into the hub groove 33. After the second tlip 18 at the left side slides into hub groove 33, the friction between the hub 30 and the tire will be greatly reduced, and at this time, once the emergency braking is performed, a relative rotation will inevitably occur between the hub 30 and the tire, losing the control of the brake. In addition, after the second lip 18 slides into hub groove 33, the steering sensitivity may become poor, resulting in the loss of control of the steering, and the second rim flange 35 adjacent to the hub groove 33 may directly contact with the level ground 60, which may easily cause traffic accidents such as turnover and drifting.

### Example 1

This embodiment provides a tubeless pneumatic tire, which is used for a steering wheel. As shown in FIGS. 4, 8 and 12, on a hub 30, a first rim flange 31 away from a hub groove 33 and a second rim flange 35 close to the hub groove 33 have the same shape and diameter, and in a tubeless pneumatic tire hub assembly 40, a tubeless pneumatic tire 10 is provided on a rim 37. A first apex 13 on a first bead 12 at one side of the tubeless pneumatic tire 10 is made of a reinforced rubber having a large rigidity and strength, and the rigidity and strength of the first apex 13 are respectively greater than the rigidity and strength of a second apex 19 at another side of the tubeless pneumatic tire 10. A first lip 17 at the same side as the first bead 12 is provided on a first bead seat 32 away from the hub groove 33 and a second lip 18 at the same side as a second bead 15 is provided on a second bead seat 34 close to the hub groove 33. When a vehicle is stationary on a level ground 60 and the tubeless pneumatic tire 10 is flattened without support by air pressure, a camber of the steering wheel will be positive and the tubeless pneumatic tire 10 at a side away from the hub groove 33 will bear all load.

Once a puncture occurs during the high-speed driving on the level ground 60, the tubeless pneumatic tire 10 will be flattened and bear all load at a side away from the hub groove 33.

When the level ground 60 applies a rightward lateral force to the tubeless pneumatic tire 10, the second lip 18 at the left side will not slide from the second bead seat 34 on the rim 37 close to the hub groove 33 into the hub groove 33, avoiding the loss of control of braking and steering and ensuring the driving safety.

When the level ground 60 applies a leftward lateral force to the tubeless pneumatic tire 10, the first lip 17 at the right side will slide from the first bead seat 32 away from the hub groove 33, and since the first lip 17 at the right side is away from the hub groove 33, the first lip 17 at the right side will not slide into the hub groove 33. A sidewall of the first lip 17 at the right side is made of a silicone rubber having a larger coefficient of friction than the natural rubber with respect to a rim inner surface 36, so that, after the slide, a large friction is generated between the sidewall of the first lip 17 at the right side and the rim inner surface 36, avoiding the loss of control of braking and steering and ensuring the driving safety.

### Example 2

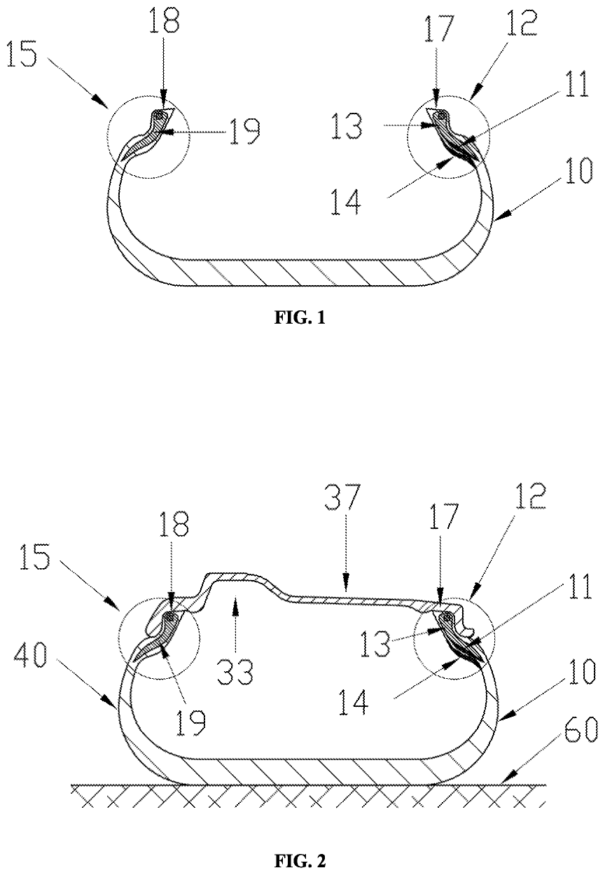

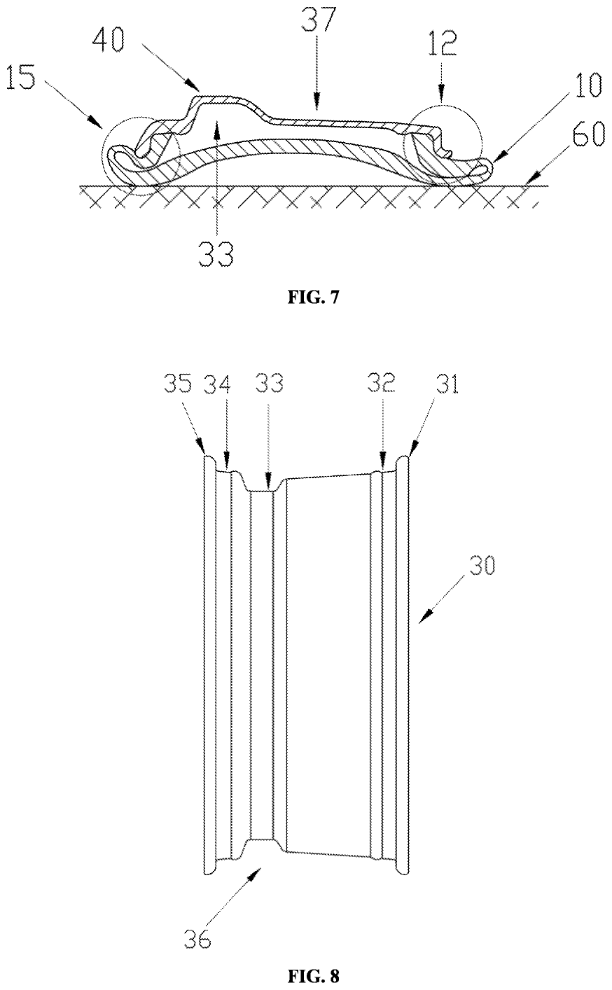

This embodiment provides a tubeless pneumatic tire, which is shown in FIGS. 1, 2, 7 and 8. On a hub 30, a first rim flange 31 away from a hub groove 33 and a second rim flange 35 close to the hub groove 33 have the same shape and diameter, and in a tubeless pneumatic tire hub assembly 40, a tubeless pneumatic tire 10 is provided on a rim 37. A first apex 13 on a first bead 12 at one side of the tubeless pneumatic tire 10 has a larger size than a second apex 19 at another side of the tubeless pneumatic tire 10. An inner surface of the first bead is provided with a second thickening portion 14 and an inner side of the first apex 13 is provided with a third thickening portion 11. A first tire bead 17 of the first bead 12 is provided on a first bead seat 32 away from the hub groove 33 and a second lip 18 of a second bead 15 is provided on a second bead seat 34 close to the hub groove 33. When a vehicle is stationary on a level ground 60 and the tubeless pneumatic tire 10 is flattened without support by air pressure, the two inner surfaces of the tire at the first bead 12 are pressed and attached together while the two inner surfaces at the second bead 15 are not attached together after being pressed, so that the tubeless pneumatic tire 10 at a side away from the hub groove 33 bears all e load.

Once a puncture occurs during the high-speed driving on the level ground 60, the tubeless pneumatic tire 10 will be flattened and bear all load at the side away from the hub groove 33.

When the level ground 60 applies a rightward lateral force to the tubeless pneumatic tire 10, the second lip 18 at the left side will not slide from the second bead seat 34 on the rim 37 close to the hub groove 33 into the hub groove 33, avoiding the loss of control of braking and steering and ensuring the driving safety.

When the level ground 60 applies a leftward lateral force to the tubeless pneumatic tire 10, the first tire bead 17 at the right side will slide from the first bead seat 32 away from the hub groove 33, and since the first lip 17 at the right side is away from the hub groove 33, the first lip 17 at the right side will not slide into the hub groove 33. A sidewall of the first lip 17 at the right side is made of a material having a larger coefficient of friction than the natural rubber with respect to a rim inner surface 36, so that, after the slide, a large friction is generated between the sidewall of the first lip 17 at the right side and the rim inner surface 36, avoiding the loss of control of braking and steering and ensuring the driving safety.

### Example 3

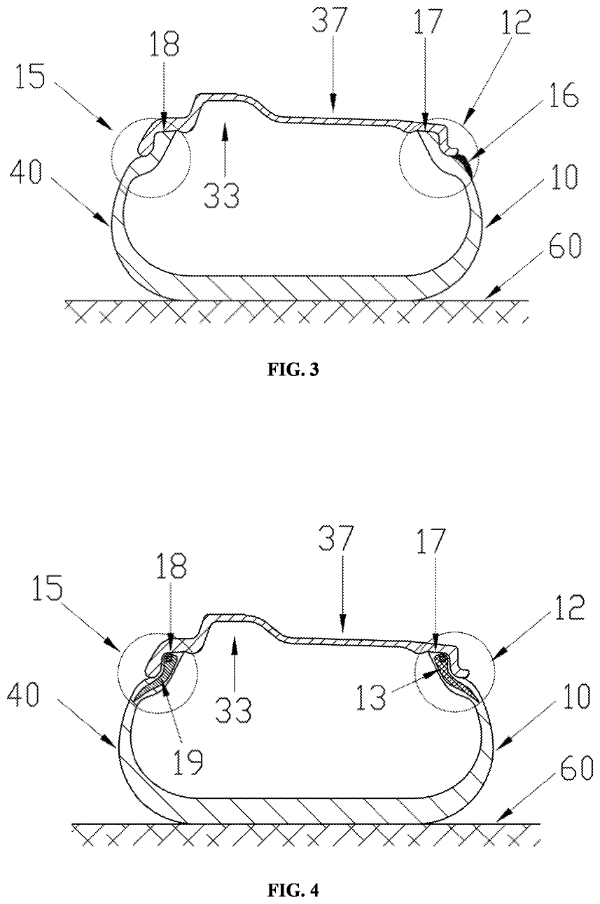

This embodiment provides a tubeless pneumatic tire, which is shown in FIGS. 3, 7 and 8. On a hub 30, a first rim flange 31 away from a hub groove 33 and a second rim flange 35 close to the hub groove 33 have the same shape and diameter, and in a tubeless pneumatic tire hub assembly 40, a tubeless pneumatic tire 10 is provided on a rim 37. A first thickening portion 16 is merely provided at the first bead 12 at an outer surface above a first rim flange 31. A first lip 17 of the first bead 12 is provided on a first bead seat 32 away from the hub groove 33 and a second lip 18 of a second bead 15 is provided on a second bead seat 34 close to the hub groove 33. When a vehicle is stationary on a level ground 60 and the tubeless pneumatic tire 10 is flattened without support by air pressure, the two inner surfaces of the tire at the first bead 12 are pressed and attached together while the two inner surfaces at the second bead 15 are not attached together after being pressed, so that the tubeless pneumatic tire 10 bears all load at a side away from the hub groove 33.

Once a puncture occurs during the high-speed driving on the level ground 60, the tubeless pneumatic tire 10 will be flattened and bear all load at the side away from the hub groove 33.

When the level ground 60 applies a rightward lateral force to the tubeless pneumatic tire 10, the second lip 18 at the left side will not slide from the second bead seat 34, close to the hub groove 33, on the rim 37 into the hub groove 33, avoiding the loss of control of braking and steering and ensuring the driving safety.

When the level ground 60 applies a leftward lateral force to the tubeless pneumatic tire 10, the first lip 17 at the right side will slide from the first bead seat 32 away from the hub groove 33, and since the first tire bead 17 at the right side is away from the hub groove 33, the first lip 17 at the right side will not slide into the hub groove 33. A sidewall of the first tire bead 17 at the right side is made of a material having a larger coefficient of friction than the natural rubber with respect to a rim inner surface 36, so that, after the slide, a large friction is generated between the sidewall of the first lip 17 at the right side and the rim inner surface 36, avoiding the loss of control of braking and steering and ensuring the driving safety.

### Example 4

This embodiment provides a tubeless pneumatic tire, which is obtained by merely improving the rigidity and/or strength of the first apex 13 at one side of the first bead 12 of the tubeless pneumatic tire in Embodiments 2 and 3. Specifically, the first apex 13 at one side of the first bead 12 is made of a reinforced rubber with a relatively large rigidity and strength, which can ensure that the tire has a desirable bearing capacity and a less increase in the weight.

### Example 5

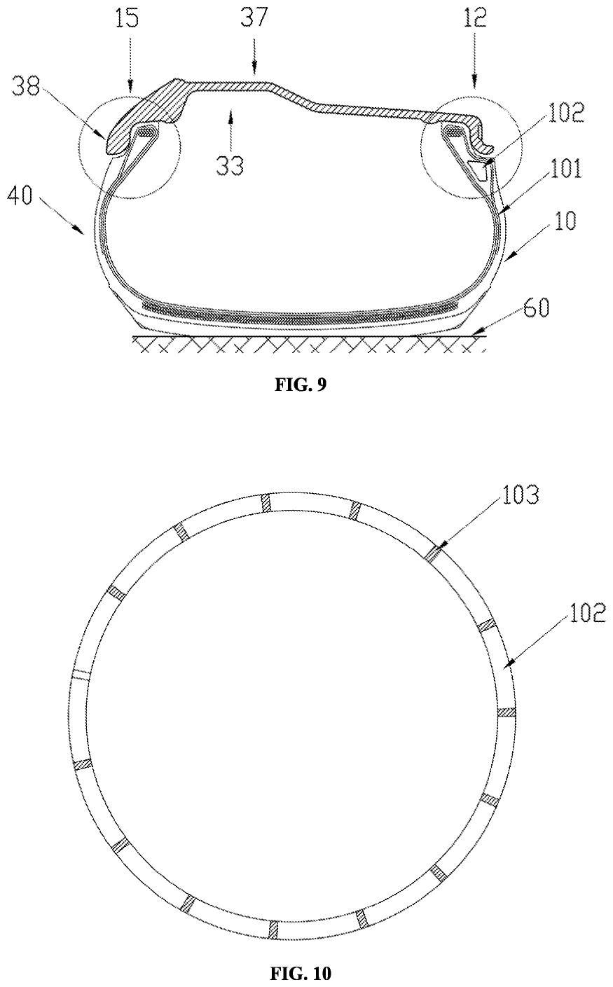

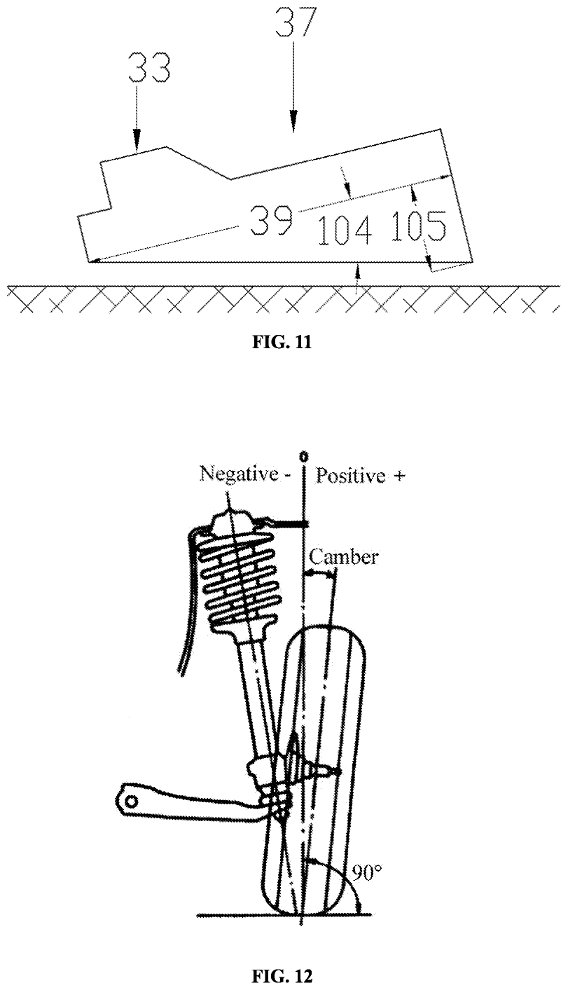

This embodiment provides a tubeless pneumatic tire, which is shown in FIGS. 8-11. The wheel is a front wheel and the hub outside 38 is adjacent to the hub groove 33. The first bead 12 is provided at the first bead seat 32 away from the hub groove 33. The reinforcing members 102 are only provided in the first bead 12 and distributed annularly and uniformly around the first bead 12. A gap 103 provided between the adjacent reinforcing members 102 is filled with a rubber material. The reinforcing member 102 is made of a low-density aluminum alloy material and has a cross section of “I” shape.

The reinforcing member 102 is coated with a cord ply 101, which can prevent the reinforcing member 102 from falling off in use. The rubber material filled in the gap 103 between the adjacent reinforcing members 102 can ensure that the bead has a certain bendability and deformability and the tire can be successfully assembled and disassembled.

The height difference 105 is equal to a product of the distance 39 between the projections of the first rim flange 31 and the second rim flange 35 in an axial direction of the rim 37 and a tangent of an angle 104 equal to the camber. A height of the reinforcing member 102 in a direction of the tire diameter is 5 mm greater than the height difference 105, which can ensure that after the tire is flattened without support by air pressure, the reinforcing members 102 at the side of the first bead 12 can bear most load. In addition, the reinforcing members 102 have a certain width, which can ensure a larger contact area with the first rim flange 31 away from the hub groove 33, protecting the first rim flange 31 from being excessively impacted and from being damaged.

Through such an arrangement, the second tire bead 18 can be avoided sliding into the hub groove when the tire is free of air pressure on a flat road, avoiding the loss of control of braking and steering and ensuring the driving safety.

### Example 6

This embodiment provides a tubeless pneumatic tire, which is different from the tire of Embodiment 5 in that the first bead 12 and the second bead 15 respectively at two sides of the tire have the same size and the reinforcing members 102 are merely provided on the first bead seat 32 away from the hub groove 33.

### Example 7

This embodiment provides a tubeless pneumatic tire, which is different from the tire of Embodiment 5 in that the reinforcing member 102 may have a cross-section of other shapes, such as circle and polygon.

The order of the above embodiments is merely intended to facilitate the description, and has nothing to do with the pros and cons of respective embodiments.

It should be noted that these embodiments are merely illustrative of the invention but are not intended to limit the invention. It should be understood by those skilled in the art that any equivalent modifications or replacements made to these embodiments without departing from the spirit of the invention should fall within the scope of the invention.

What is claimed is:

1. A tubeless pneumatic tire, comprising: a first bead and a second bead;
wherein a rigidity of the first bead is greater than a rigidity of the second bead, and/or a strength of the first bead is greater than a strength of the second bead;
a first lip at the same side as the first bead is provided on a first bead seat away from a hub groove; and
a second lip at the same side as the second bead is provided on a second bead seat close to the hub groove.

2. The tubeless pneumatic tire of claim 1, wherein when a vehicle is stationary on a level ground and the tubeless pneumatic tire is flattened without support by air pressure, an inner surface of the first bead is attached to an inner surface of the tubeless pneumatic tire and the tubeless pneumatic tire at a side away from the hub groove bears all or most load.

3. The tubeless pneumatic tire of claim 2, wherein a load borne by the tubeless pneumatic tire at the side away from the hub groove is at least 1.1 times more than the tubeless pneumatic tire at a side close to the hub groove.

4. The tubeless pneumatic tire of claim 1, wherein the first bead is greater than the second bead in outer size.

5. The tubeless pneumatic tire of claim 4, wherein the first bead is provided with a first thickening portion at an outer surface above a first rim flange away from the hub groove, and/or an inner surface of the first bead is provided with a second thickening portion.

6. The tubeless pneumatic tire of claim 4, wherein the first bead comprises a first apex; the second bead comprises a second apex; and the first apex is greater than the second apex in outer size.

7. The tubeless pneumatic tire of claim 1, wherein at least one of materials used in respective portions of the first bead has a rigidity greater than that of a material used in the corresponding portion of the second bead, and/or has a strength greater than that of a material used in the corresponding portion of the second bead.

8. The tubeless pneumatic tire of claim 7, wherein the first bead comprises a first apex; the second bead comprises a second apex; and a rigidity of the first apex is greater than that of the second apex, and/or a strength of the first apex is greater than that of the second apex.

9. The tubeless pneumatic tire of claim 1, wherein a first rim flange away from the hub groove is the same as a second rim flange close to the hub groove in diameter; and the second rim flange is arranged at an outside of a vehicle.

10. The tubeless pneumatic tire of claim 1, wherein the second bead is arranged on the second bead seat at an outside of a vehicle; the first bead is provided with a plurality of reinforcing members at a position above a first rim flange away from the hub groove; the plurality of reinforcing members, with an elastic modulus at 20° C. of more than 2000 MPa, are uniformly distributed on a circumference of the first bead.

11. The tubeless pneumatic tire of claim 10, wherein the reinforcing members are made of aluminum alloy, steel, alloy steel, zinc alloy, carbon fiber, nylon or glass fiber.

12. The tubeless pneumatic tire of claim 11, wherein the reinforcing members are formed by die casting, injection molding, forging or extrusion.

13. The tubeless pneumatic tire of claim 10, wherein when a vehicle is stationary on a level ground and the tubeless pneumatic tire is flattened without support by air pressure, a height of the reinforcing members along a diameter of the tubeless pneumatic tire is greater than a product of a distance between projections of the first rim flange and a second rim flange in an axial direction of a rim and a tangent value of a wheel camber.

14. A tubeless pneumatic tire, comprising a first bead and a second bead;
wherein the first bead is greater than the second bead in outer size;
a first lip at the same side as the first bead is provided on a first bead seat away from a hub groove; and
a second lip at the same side as the second bead is provided on a second bead seat close to the hub groove.

15. The tubeless pneumatic tire of claim 14, wherein the first bead is provided with a first thickening portion at an outer surface above a first rim flange away from the hub groove, and/or an inner surface of the first bead is provided with a second thickening portion.

16. The tubeless pneumatic tire of claim 14, wherein when a vehicle is stationary on a level ground and the tubeless pneumatic tire is flattened without support by air pressure, an inner surface of the first bead is attached to an inner surface of the tubeless pneumatic tire and the tubeless pneumatic tire at a side away from the hub groove bears all or most load.

17. The tubeless pneumatic tire of claim 16, wherein a load borne by the tubeless pneumatic tire at the side away from the hub groove is at least 1.1 times more than the tubeless pneumatic tire at a side adjacent to the hub groove.

18. The tubeless pneumatic tire of claim 14, wherein the first bead comprises a first apex; the second bead comprises a second apex; and the first apex is greater than the second apex in outer size.

19. The tubeless pneumatic tire of claim 14, wherein a first rim flange away from the hub groove is the same as a second rim flange close to the hub groove in diameter; and the second rim flange is arranged at an outside of a vehicle.

20. The tubeless pneumatic tire of claim 14, wherein the first bead is greater than the second bead in height.
